(19) United States
(12) Patent Application Publication
(10) Pub. No.: US 2026/0314791 A1
(43) Pub. Date: Oct. 15, 2026

(54) INTELLIGENT HAIR DRYER WITH DISTANCE MEASUREMENT FUNCTION

(71) Applicant: HONG KONG TUNG HEI YUEN TECHNOLOGY CO., LIMITED, Hong Kong (HK)

(72) Inventors: Shuo Cao, Hong Kong (HK); Yongshan Chen, Hong Kong (HK); Xiangxin Huang, Hong Kong (HK)

(21) Appl. No.: 19/674,420

(22) Filed: May 12, 2026

(30) Foreign Application Priority Data
May 13, 2025 (CN) 202510614079.5

(51) Int. Cl. A45D 20/12; G01K 1/14; G01S 7/4865; G01S 17/10

(52) U.S. Cl. CPC A45D 20/12; G01K 1/14; G01S 7/4865; G01S 17/10

(57) ABSTRACT

An intelligent hair dryer with a distance measurement function is provided, including a barrel and a handle connected to the barrel. A control unit is disposed inside the barrel and/or the handle. A distance measurement module is arranged on the handle or at a position of connection between the barrel and the handle, and is electrically connected to the control unit. The distance measurement module is moved from a position of an air outlet of the barrel that is susceptible to a high temperature to the handle or the position of connection between the barrel and the handle, and is effectively kept away from a large amount of heat generated during operation of the barrel, thus greatly reducing interference of the high temperature with an internal electronic element of the distance measurement module, and ensuring stable operation of the distance measurement module.

### TECHNICAL FIELD

The present disclosure relates to the technical field of hair dryers, and specifically, to an intelligent hair dryer with a distance measurement function.

### BACKGROUND

In the field of hair care, a hair dryer is one of the commonly used electrical appliances in daily life. The traditional hair dryer has relatively simple functions and mainly dries hairs by simply adjusting a wind speed and a temperature. However, in actual use, a distance between the hair dryer and the hairs plays a crucial role in the hair care effect and the drying efficiency.

When the hair dryer is too close to the hairs, a high-temperature air flow is concentrated on a local part of the hairs within short time. It easily leads to excessive moisture loss of the hairs, damages the cuticles of the hairs, and further causes problems such as dry hairs, frizzy hairs, split ends, and even broken hairs. Meanwhile, an excessively short distance may also pose a risk of scalding to the scalp and affect the health of the scalp. On the other hand, if the hair dryer is too far from the hairs, although the risk of damage to the hairs and the scalp can be lowered, wind power and heat will be greatly lost during transferring. This fails to dry the hairs effectively, resulting in a significant increase in drying time. It wastes time and increases energy consumption.

To this end, a hair dryer with a distance sensor have emerged. It can accurately measure a distance between the hair dryer and the hairs, and prevent, through automatic adjustment, hair damage caused by an excessively short distance or a decrease in the drying efficiency caused by an excessively long distance, thus greatly enhancing the user experience and the hair care effect.

In such a hair dryer, a mounting position of the distance sensor is of critical importance. In many designs, the distance sensor is mounted at an air outlet of a barrel (such as a middle position or an outer ring of the barrel). This position can directly and accurately measure a real-time distance between the hair dryer and the hairs. For example, in a Chinese patent “hair dryer” No. CN113040498A, a distance sensor of the hair dryer can measure a distance between a first air outlet of a main body and a measured human body, and a control panel can control working states of a heating assembly and a blower assembly according to a distance signal of the distance sensor.

However, the barrel, as a heating component of the hair dryer, generates a large amount of heat during operation. When the distance sensor is located at the air outlet of the barrel, it is highly susceptible to a high-temperature environment. In one aspect, a high temperature may cause changes in the performance of internal elements of the sensor, such as in a resistance value and a capacitance value of an electronic element, thereby greatly reducing the measurement accuracy of the sensor and failing to accurately feed back an actual distance between the hair dryer and the hairs. In another aspect, long-term exposure to the high-temperature environment may even lead to a fault or a complete failure of the sensor. This severely affects the reliability of the distance measurement function of the hair dryer, and also restrains the effect of the product in actual use. There is an urgent need for a more perfect technical solution to solve this problem.

### SUMMARY

To overcome the drawbacks described above, the present disclosure aims to provide a technical solution that can solve the above problems.

An intelligent hair dryer with a distance measurement function includes a barrel and a handle connected to the barrel. A control unit is disposed inside the barrel and/or the handle. A distance measurement module is arranged on the handle or at a position of connection between the barrel and the handle. The distance measurement module is electrically connected to the control unit.

In a further solution of the present disclosure, a measurement direction of the distance measurement module is consistent with an air outlet direction of the barrel.

In a further solution of the present disclosure, the barrel is rotatably connected to the handle. The distance measurement module is arranged at a position of rotatable connection between the barrel and the handle.

In a further solution of the present disclosure, the distance measurement module can rotate as the barrel rotates, to cause the measurement direction of the distance measurement module to be always consistent with the air outlet direction of the barrel.

In a further solution of the present disclosure, a rotatable connection member is disposed for mating between the barrel and the handle. One end of the rotatable connection member is fixedly connected to the barrel, and another end of the rotatable connection member is rotatably connected to the handle.

The distance measurement module is fixedly connected to the rotatable connection member.

In a further solution of the present disclosure, the rotatable connection member includes a fixed end corresponding to the barrel, and a rotating shaft end corresponding to the handle. An opening mated with the rotating shaft end is formed in one side of the handle facing the air outlet of the barrel. The distance measurement module is fixedly connected to the rotating shaft end and corresponds to the opening.

In a further solution of the present disclosure, a mounting position for accommodating the distance measurement module is disposed within the rotating shaft end. A window communicated with the mounting position is formed along a surface of the rotating shaft end. A transparent part corresponding to the distance measurement module is connected to the window.

In a further solution of the present disclosure, within an allowable angle range of rotation of the barrel relative to the handle, the rotating shaft end of the rotatable connection member is at least partially located at the opening to cause the measurement direction of the distance measurement module to be always consistent with the air outlet direction of the barrel.

In a further solution of the present disclosure, the distance measurement module is a laser distance measurement sensor or an infrared distance measurement sensor.

In a further solution of the present disclosure, a slot mated with the rotating shaft end of the rotatable connection member is provided in a position, corresponding to the position of connection between the handle and the barrel, on the handle. The opening is formed in one side of the slot.

In a further solution of the present disclosure, a temperature sensing element is disposed inside the barrel. The temperature sensing element is electrically connected to the control unit.

The control unit dynamically adjusts an air outlet temperature of the barrel based on distance information measured by the distance measurement module and temperature information measured by the temperature sensing element.

Compared with the prior art, the present disclosure has the beneficial effects below:

The distance measurement module is moved from the position of the air outlet of the barrel that is susceptible to a high temperature to the handle or the position of connection between the barrel and the handle, and is effectively kept away from a large amount of heat generated during operation of the barrel, thus greatly reducing interference of the high temperature with an internal electronic element of the distance measurement module, ensuring stable operation of the distance measurement module, significantly enhancing distance measurement accuracy, ensuring reliability of the distance measurement function of the hair dryer, and allowing a user to obtain a more accurate distance feedback to implement more scientific hair care.

The additional aspects and advantages of the present disclosure will be set forth in part in the description below, parts of which will become apparent from the description below, or will be understood by the practice of the present disclosure.

### BRIEF DESCRIPTION OF THE DRAWINGS

To describe the technical solutions in the embodiments of the present disclosure or in the related art more clearly, the following briefly introduces the accompanying drawings for describing the embodiments or the related art. Apparently, the accompanying drawings in the following description show merely some embodiments of the present disclosure, and a person of ordinary skill in the art may still derive other drawings from the accompanying drawings without creative efforts.

FIG. 1 is a schematic diagram of a structure of the present disclosure;

FIG. 2 is a schematic diagram of a structure of mating between a rotatable connection member and a distance measurement module in the present disclosure;

FIG. 3 is a schematic diagram of an exploded structure of mating between a rotatable connection member and a distance measurement module in the present disclosure;

FIG. 4 is a schematic diagram of a structure of a handle in the present disclosure; and

FIG. 5 is a schematic cross-sectional diagram of a structure of the present disclosure.

Reference numerals and names in the accompanying drawings are as follows: 1: barrel; 2: handle; 3: control unit; 4: distance measurement module; 5: rotatable connection member; 6: fixed end; 7: rotating shaft end; 8: opening; 9: mounting position; 10: window; 11: transparent part; 12: slot; and 13: air outlet.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are some of the embodiments of the present disclosure rather than all the embodiments. All other embodiments obtained by a person of ordinary skill in the art based on the disclosed embodiments without creative efforts shall fall within the protection scope of the present disclosure.

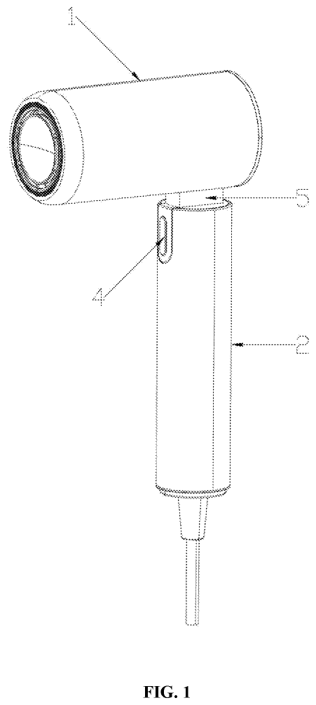

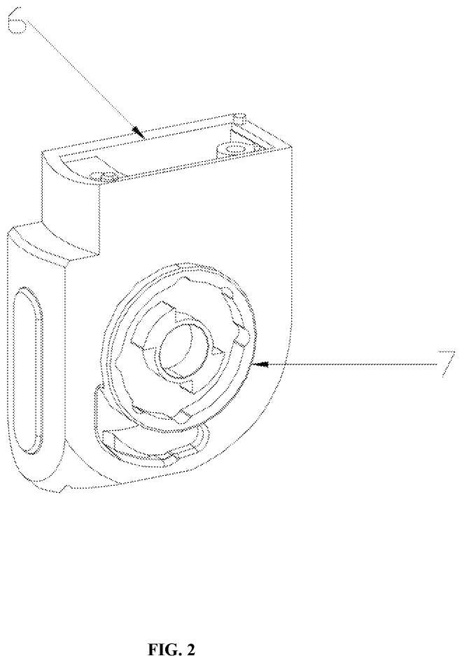

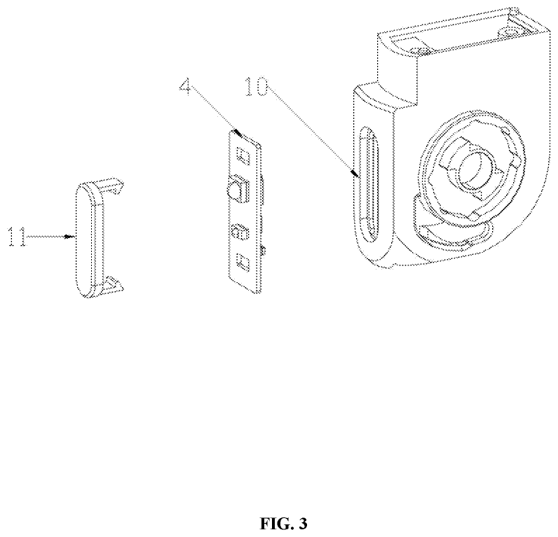

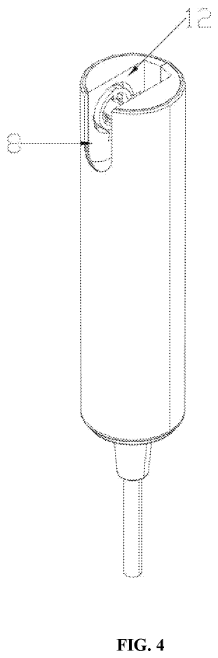

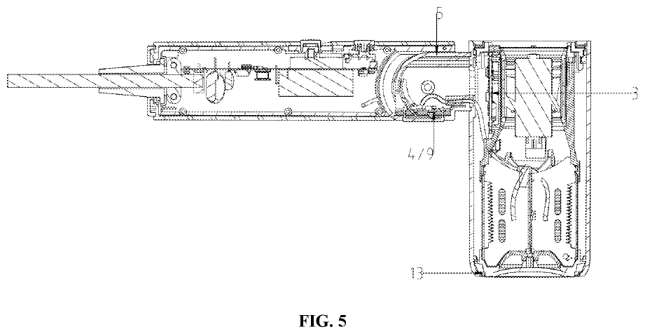

Referring to FIG. 1 to FIG. 5, in an embodiment of the present disclosure, an intelligent hair dryer with a distance measurement function includes a barrel 1 and a handle 2 connected to the barrel. A control unit 3 is disposed inside the barrel 1 and/or the handle 2. A distance measurement module 4 is arranged on the handle 2 or at a position of connection between the barrel 1 and the handle 2. The distance measurement module 4 is electrically connected to the control unit 3.

In the technical solution of the present disclosure, the distance measurement module 4 is mounted on the handle 2 or at the position of connection between the barrel 1 and the handle 2. When a user uses the hair dryer, the distance measurement module 4 will continuously work, its internal sensing element is used to measure a distance between the hair dryer and the hairs in real time by emitting and receiving specific signals (such as infrared signals or ultrasonic wave signals. Once the distance measurement module 4 obtains distance data, it will immediately convert the distance data into an electrical signal and transmit the electrical signal to the control unit 3 disposed inside the barrel 1 and/or the handle 2 through an electric connection line.

The control unit 3, as the “brain” of the entire intelligent hair dryer, can analyze and process the electric distance signal transmitted by distance measurement module 4 according to a preset program algorithm and a logical rule after receiving the electric distance signal. For example, when it is measured that the distance is too close, the control unit 3 can send an instruction to a heating assembly inside the hair dryer to reduce heating power to avoid hair damage caused by a high temperature, or send an instruction to the heating assembly and a blower assembly inside the hair dryer to reduce the heating power to avoid the hair damage caused by the high temperature, while appropriately reducing a wind speed to prevent excessive concentration of wind power from causing impact on the hairs. If it is measured that the distance is too far, the control unit 3 can increase the heating power or increase the heating power and the wind speed to enhance drying efficiency.

The distance measurement module 4 is moved from a position of an air outlet 13 of the barrel 1 that is susceptible to a high temperature to the handle 2 or the position of connection between the barrel 1 and the handle 2, and is effectively kept away from a large amount of heat generated during operation of the barrel 1, thus greatly reducing interference of the high temperature with an internal electronic element of the distance measurement module 4, ensuring stable operation of the distance measurement module 4, significantly enhancing distance measurement accuracy, ensuring reliability of the distance measurement function of the hair dryer, and allowing a user to obtain a more accurate distance feedback to implement more scientific hair care.

In this embodiment of the present disclosure, a measurement direction of the distance measurement module 4 is consistent with an air outlet direction of the barrel 1.

Based on considerations on an actual usage scenario of the hair dryer, a measurement signal (such as infrared ray or ultrasonic waves) emitted by the distance measurement module 4 can be propagated linearly in the air outlet direction of the barrel 1. In this way, when the hair dryer operates, a path of an air flow blown out by the barrel 1 coincides with a path of the distance measurement module 4 for measuring the distance from the hairs. This enables the distance measurement module 4 to accurately perform distance measurement on the hairs that are within a working range of hot air. The principle is similar to a situation that in a straight channel, while blowing hot air, a distance between a target (the hairs) in the channel and the hair dryer is synchronously measured, thus ensuring timeliness and accuracy of measurement.

The air outlet direction of the barrel 1 determines a region in which the hot air acts on the hairs. Keeping the measurement direction of the distance measurement module 4 consistent with the air outlet direction can ensure that the measured distance is an actual distance between the hairs being blown by the hot air and the hair dryer. This effectively avoids a phenomenon, caused by a deviation in the measurement direction, that the measured position is not the hair position being blown by the hot air, thus implementing accurate control of the distance between the working region of the hot air and the hairs, providing a reliable basis for subsequent distance-based intelligent control, and greatly enhancing a degree of matching between distance measurement and an actual hair care scenario.

When the measurement direction is consistent with the air outlet direction, once the distance between the hairs and the hair dryer changes, the distance measurement module 4 can capture this change in the first time and quickly transmit the distance data to the control unit 3. Based on timely and accurate distance information, the control unit 3 can quickly control the heating assembly, or the heating assembly and the blower assembly. For example, when the hairs suddenly approach the hair dryer and the distance is shortened, the distance measurement module 4 immediately senses it and transmits a signal. The control unit 3 quickly reduces the heating power and the wind speed to prevent hair damage due to a short distance. This greatly enhances timeliness and effectiveness of intelligent control and ensures safety and efficiency of a hair care process in all aspects.

In this embodiment of the present disclosure, the barrel 1 is rotatably connected to the handle 2. The distance measurement module 4 is arranged at a position of rotatable connection between the barrel 1 and the handle 2.

The distance measurement module 4 can rotate as the barrel 1 rotates, to cause the measurement direction of the distance measurement module 4 to be always consistent with the air outlet direction of the barrel 1.

Since the barrel 1 and the handle 2 are rotatable, a user can flexibly change an angle of the barrel 1 when using the hair dryer for complex hair styling. With the rotation of the barrel 1, the distance measurement module 4 ensures that regardless of the angle of the barrel 1, the distance between the hairs in the air outlet direction of the barrel 1 and the hair dryer can be continuously and accurately measured. This ensures that in various usage scenarios, the measured distance data is targeted at the hairs being blown by the hot air, thus effectively avoiding a problem of disconnection between a measurement region and a blowing region due to a change in the angle of the barrel 1, ensuring that the distance-based intelligent control always acts on an actually desired hair position, enhancing adaptability of the intelligent hair dryer to different styling operations, and significantly enhancing accuracy and effectiveness of distance measurement and intelligent control.

In this embodiment of the present disclosure, a rotatable connection member 5 is disposed for mating between the barrel 1 and the handle 2. One end of the rotatable connection member 5 is fixedly connected to the barrel 1, and another end of the rotatable connection member 5 is rotatably connected to the handle 2.

The distance measurement module 4 is fixedly connected to the rotatable connection member 5.

One end of the rotatable connection member 5 is fixedly connected to the barrel 1 to ensure that they become a stable whole. The rotation of the barrel 1 will inevitably drive the end of the rotatable connection member 5 to rotate synchronously, and another end of the rotatable connection member 5 is rotatably connected to the handle 2, thus endowing the barrel 1 a capability of rotating flexibly relative to the handle 2. The distance measurement module 4 is fixedly connected to the rotatable connection member 5. With the help of the transmission effect of the rotatable connection member 5, when the barrel 1 rotates, the rotatable connection member 5 drives the distance measurement module 4 to rotate together.

By fixing the distance measurement module 4 on the rotatable connection member 5 and synchronously transmitting the rotation of the barrel 1 through the rotatable connection member 5, stability of the distance measurement module 4 in a complex use process is ensured. When the barrel 1 rotates, the distance measurement module 4 will not shake or move due to unstable mounting, thus continuously and accurately measuring the distance between the hair dryer and the hairs. For example, in long-term and multi-angle hair styling operations, the distance measurement module 4 can work stably to provide accurate distance data to the control unit 3, thus ensuring reliability of intelligent control and effectively enhancing stability and durability of the distance measurement function of the hair dryer.

The rotatable connection member 5, as a carrier for the distance measurement module 4, cleverly uses a space at the position of connection between the barrel 1 and the handle 2. Compared with the separate arrangement of the distance measurement module 4 in another position, this design avoids occupation of an additional limited space inside or outside the hair dryer, thus making the overall structural layout more compact and appropriate. Meanwhile, integrating the distance measurement module 4 onto the rotatable connection member 5 reduces complex wiring and separately mounted structures, reduces complexity of product design and manufacturing, enhances production efficiency, and provides possibilities for a miniaturized and lightweight design of products.

In this embodiment of the present disclosure, the rotatable connection member 5 includes a fixed end 6 corresponding to the barrel 1, and a rotating shaft end 7 corresponding to the handle 2; An opening 8 mated with the rotating shaft end 7 is formed in one side of the handle 2 facing the air outlet 13 of the barrel 1. The distance measurement module 4 is fixedly connected to the rotating shaft end 7 and corresponds to the opening 8.

The fixed end 6 is closely connected to the barrel 1 to ensure the stability of the barrel 1 during rotation, so that the rotation of the barrel 1 can be accurately transmitted to the entire connected structure. The rotating shaft end 7 is mated with the opening 8 specially formed in the handle 2. The opening 8 provides a space for the movement of the rotating shaft end 7 and defines a trajectory and range of rotation at the same time. The distance measurement module 4 is mounted at the rotating shaft end 7 and corresponds to the opening 8. When the barrel 1 drives the rotatable connection member 5 to rotate through the fixed end 6, the rotating shaft end 7 rotates inside the opening 8, thereby driving the distance measurement module 4 to rotate synchronously.

The distance measurement module 4 is arranged at the position, corresponding to the opening 8, on the rotating shaft end 7, so that the measurement direction of the distance measurement module 4 can accurately follow the change in the air outlet direction of the barrel 1. No matter how the barrel 1 rotates, the distance measurement module 4 can always be aligned with the hair region pointed to by the air outlet 13 of the barrel 1, to accurately measure the distance.

In this embodiment of the present disclosure, a mounting position 9 for accommodating the distance measurement module 4 is disposed within the rotating shaft end 7. A window 10 communicated with the mounting position 9 is formed along a surface of the rotating shaft end 7. A transparent part 11 corresponding to the distance measurement module 4 is connected to the window 10.

The distance measurement module 4 is ingeniously integrated inside the rotating shaft end 7, and measurement and protection functions are implemented through the window 10 and the transparent part 11, thus avoiding additional arrangement of a complex measurement device and protection structure outside the hair dryer and making the overall structure of the product more compact and appropriate.

Specifically, the mounting position 9 that accommodates the distance measurement module 4 provides a stable placement space for the distance measurement module 4. It ensures that the distance measurement module 4 will not move due to vibration or other factors when the hair dryer operates, and guarantees stable operation of the distance measurement function. The window 10 formed along the surface of the rotating shaft end 7 forms a connection channel between the distance measurement module 4 and an external environment. The transparent part 11, such as a lens, is connected to the window 10. When the distance measurement module 4 operates, the measurement signal (such as an infrared signal or an ultrasonic signal) emitted by the internal sensing element accurately penetrates through the window 10 via the transparent part 11 and reaches an external hair position for distance measurement. The transparent part 11 effectively blocks interference and damage of external factors such as dust, water vapor, and collision to an internal precision sensing element inside the distance measurement module 4, thus maintaining a stable working state of the distance measurement module 4 and implementing an efficient and stable distance measurement function.

In this embodiment of the present disclosure, within an allowable angle range of rotation of the barrel 1 relative to the handle 2, the rotating shaft end 7 of the rotatable connection member 5 is at least partially located at the opening 8 to cause the measurement direction of the distance measurement module 4 to be always consistent with the air outlet direction of the barrel 1.

In the overall structural design of the intelligent hair dryer, the barrel 1 and the handle 2 are connected through the rotatable connection member 5. The rotating shaft end 7 of the rotatable connection member 5 cooperates with the opening 8 on the handle 2. The allowable angle range of rotation of the barrel 1 relative to the handle 2 is set in advance. Within this range, the sizes and shapes of the rotating shaft end 7 and the opening 8 and a relative position relationship between them are designed to ensure that during the rotation of the barrel 1, the rotating shaft end 7 can always remain at least partially in the opening 8. Since the distance measurement module 4 is fixed at the rotating shaft end 7, the distance measurement module 4 can rotate as the barrel 1 rotates, and its measurement direction always corresponds to the air outlet direction of the barrel 1.

This means that regardless of the angle of the barrel 1, the distance measurement module 4 can accurately measure the distance between the hair region pointed to by the air outlet 13 of the barrel 1 and the hair dryer, thereby implementing precise correspondence between the measurement direction of the distance measurement module 4 and the air outlet direction of the barrel 1.

In this embodiment of the present disclosure, the distance measurement module 4 is a laser distance measurement sensor or an infrared distance measurement sensor.

By using a linear propagation characteristic of laser and stability of a light speed, the laser distance measurement sensor emits laser pulses towards target hairs, and then measures time from emission to reflection by the hairs. A relevant algorithm is used to calculate the distance between the hairs and the hair dryer. Laser has the characteristics of high directionality, high energy density, and good monochromaticity, and can implement high-precision distance measurement.

The infrared distance sensor generally uses an infrared light-emitting diode to emit infrared rays. After the infrared rays irradiate the hairs, the infrared rays will be reflected back. An infrared receiving tube receives reflected rays and uses a relevant algorithm to calculate the distance between the hairs and the hair dryer by measuring a time difference or light intensity change between the emitted rays and the received rays. The infrared rays have high penetration and anti-interference capabilities, and is relatively safe to a human body.

In this embodiment of the present disclosure, a slot 12 mated with the rotating shaft end 7 of the rotatable connection member 5 is provided in a position, corresponding to the position of connection between the handle 2 and the barrel 1, on the handle 2. The opening 8 is formed in one side of the slot 12.

The slot 12 provides a stable mounting and rotation basis for the rotating shaft end 7, and defines a rotation trajectory of the rotating shaft end 7, causing the rotating shaft end 7 to only rotate in a specific direction and range. Meanwhile, the opening 8 is formed in one side of the slot 12, and the opening 8 corresponds to the distance measurement module 4 mounted on the rotating shaft end 7. In this design, after the barrel 1 is connected to the handle 2 through the rotatable connection member 5, when the barrel 1 rotates, the rotating shaft end 7 rotates inside the slot 12. Due to the presence of the opening 8, the distance measurement module 4 can perform measurement without obstructions. The measurement direction of the distance measurement module can always be consistent with the air outlet direction of the barrel 1, thus implementing accurate measurement of the distance between the hair dryer and the hairs.

In this embodiment of the present disclosure, a temperature sensing element is disposed inside the barrel 1. The temperature sensing element is electrically connected to the control unit 3.

The control unit 3 dynamically adjusts an air outlet temperature of the barrel 1 based on distance information measured by the distance measurement module 4 and temperature information measured by the temperature sensing element.

By controlling the air outlet temperature based on the distance information and the temperature information, a risk of hair damage is greatly lowered. When the distance is too short, the air outlet temperature is automatically reduced to avoid excessive loss of hair moisture and damage to the cuticles due to concentration of a high-temperature air flow. This effectively reduces problems such as dry hairs, split ends, and broken hairs, cares for hairs'health in all aspects, and meets needs of users for high-quality hair care. Conversely, if the distance is relatively long and the temperature is appropriate, the heating power will be appropriately increased to increase the air outlet temperature, so as to ensure the drying efficiency.

For example, when the distance measurement module 4 provides a feedback that the distance between the hair dryer and the hairs is too short, and the temperature sensing element detects that the temperature inside the barrel 1 is too high, the control unit 3 determines a high risk of thermal damage to the hairs and immediately sends an instruction to reduce the power of the heating assembly, thereby dynamically lowering the air outlet temperature of the barrel 1.

In summary, from the perspective of an environmental temperature factor, heat generated by the barrel 1 during operation is mainly concentrated inside the barrel 1 and near the air outlet 13. The position of connection between the barrel 1 and the handle 2 at which the rotatable connection member 5 is located is far away from a high-temperature region inside the barrel 1, so that its temperature is relatively low and stable. This provides an ideal working environment for the distance measurement module 4, which can effectively avoid changes in the performance of the internal electronic element of the distance measurement module 4 caused by the high temperature, ensure stable operation of the internal electronic element, and continuously and accurately measure the distance between the hair dryer and hairs. From the ergonomic perspective, when a user holds and operates the hair dryer, the user naturally holds the handle 2 with a hand, and the position of the rotatable connection member 5 is outside a gripping range of the hand. The hand of the user will not touch this part during normal use. The characteristic of this position makes the rotatable connection member 5 an excellent choice for mounting the distance measurement module 4. It does not affect normal gripping of the user, and also provides a safe, stable, and interference-resistant mounting position 9 for the distance measurement module 4.

Preferably, in the design system of the intelligent hair dryer, when the distance measurement module 4 is arranged at the position of connection between the barrel 1 and the handle 2, according to an actual situation of distance measurement, this position can be approximately regarded as the position of the handle 2. Compared with directly arranging the distance measurement module 4 at the air outlet 13 of the barrel 1, this arrangement equivalently lengthens an actual measurement path by about 10 cm. To ensure that the measured distance can truly reflect the actual distance between the hair outlet 13 of the hair dryer and the hairs, compensation can be made by a software algorithm. Specifically, the software algorithm will store this distance deviation data (about 10 cm) in advance. When the distance measurement module 4 measures the distance data between the hair dryer and the hairs, the algorithm can automatically subtract this fixed deviation value (10 cm) from a measured value. For example, if a distance measured by distance measurement module 4 is 25 cm, after the software algorithm performs compensation, actual distance data received by the control unit 3 is 25 cm−10 cm=15 cm. In this way, accurate calibration of a distance is implemented, and subsequent distance-based intelligent control can be performed based on accurate distance information.

For those skilled in the art, it is apparent that the present disclosure is not limited to the details of the exemplary embodiments mentioned above, and can be implemented in other specific forms without departing from the spirit or basic features of the present disclosure. Therefore, in any perspective, the embodiments should be regarded as exemplary and non-restrictive. The scope of the present disclosure is limited by the accompanying claims rather than the above description. Therefore, all changes within the meaning and scope of the equivalent conditions of the claims within the present disclosure.

What is claimed is:

1. An intelligent hair dryer with a distance measurement function, comprising a barrel and a handle connected to the barrel, wherein a control unit is disposed inside the barrel and/or the handle; a distance measurement module is arranged at a position of connection between the barrel and the handle; the distance measurement module is electrically connected to the control unit;
a measurement direction of the distance measurement module is consistent with an air outlet direction of the barrel;
the barrel is rotatably connected to the handle; and the distance measurement module is able to rotate as the barrel rotates, to cause the measurement direction of the distance measurement module to be always consistent with the air outlet direction of the barrel.

2. The intelligent hair dryer with the distance measurement function according to claim 1, wherein a rotatable connection member is disposed for mating between the barrel and the handle; one end of the rotatable connection member is fixedly connected to the barrel;
another end of the rotatable connection member is rotatably connected to the handle; and
the distance measurement module is fixedly connected to the rotatable connection member.

3. The intelligent hair dryer with the distance measurement function according to claim 2, wherein the rotatable connection member comprises a fixed end corresponding to the barrel, and a rotating shaft end corresponding to the handle; an opening mated with the rotating shaft end is formed in one side of the handle facing the air outlet of the barrel; and
the distance measurement module is fixedly connected to the rotating shaft end and corresponds to the opening.

4. The intelligent hair dryer with the distance measurement function according to claim 3, wherein a mounting position for accommodating the distance measurement module is disposed within the rotating shaft end; a window communicated with the mounting position is formed along a surface of the rotating shaft end; and a transparent part corresponding to the distance measurement module is connected to the window.

5. The intelligent hair dryer with the distance measurement function according to claim 3, wherein within an allowable angle range of rotation of the barrel relative to the handle, the rotating shaft end of the rotatable connection member is at least partially located at the opening to cause the measurement direction of the distance measurement module to be always consistent with the air outlet direction of the barrel.

6. The intelligent hair dryer with the distance measurement function according to claim 1, wherein the distance measurement module is a laser distance measurement sensor or an infrared distance measurement sensor.

7. The intelligent hair dryer with the distance measurement function according to claim 3, wherein a slot mated with the rotating shaft end of the rotatable connection member is provided in a position, corresponding to the position of connection between the handle and the barrel, on the handle; and the opening is formed in one side of the slot.

8. The intelligent hair dryer with the distance measurement function according to claim 1, wherein a temperature sensing element is disposed inside the barrel; the temperature sensing element is electrically connected to the control unit; and
the control unit dynamically adjusts an air outlet temperature of the barrel based on distance information measured by the distance measurement module and temperature information measured by the temperature sensing element.
